(19) United States
(12) Patent Application Publication
(10) Pub. No.: US 2015/0032768 A1
(43) Pub. Date: Jan. 29, 2015

(54) MANAGING ITEM QUERIES

(71) Applicant: EXPEDIA, INC., (US)

(72) Inventors: Jeffrey Stewart Miller, Seattle, WA (US); David Elias Fleischman, Issaquah, WA (US)

(73) Assignee: EXPEDIA, INC., Bellevue, WA (US)

(21) Appl. No.: 13/838,425

(22) Filed: Mar. 15, 2013

(51) Int. Cl. G06F 17/30

(52) U.S. Cl. CPC G06F 17/30477
USPC 707/769

(57) ABSTRACT

A network-based service may be provided for facilitating queries for a number of items, such as travel services. The items may be complimentary, such that users frequently desire to purchase two or more items in conjunction. A user may submit a query including criteria for determining one or more relevant items. Based on the submitted query, the network-based service may infer a desired travel plan of the user, such as a trip or vacation to a specific destination. The network-based service may use the inferred travel plan to generate queries for combinations of items that correspond to the inferred travel plan. These queries, or items corresponding to the queries, may then be returned to the user.

### BACKGROUND

Computing devices and computing networks are frequently employed by users to obtain information and to make purchases. For example, a user may search for, review, and share information regarding items of interest from a network-based information service using his or her personal computing device. In another example, a user may purchase an item of interest from a network-based retailer using his or her personal computing device. Furthermore, network-based services may enable a user to perform these task in the comfort of their home or office and at his or her own pace and convenience.

In some instances, network-based services may provide information regarding a variety of items offered from a variety of sources. For example, a network-based travel service may offer flights, accommodations (e.g., hotels, bed and breakfasts, hostels, resorts, etc.), ground transportation (car rentals, taxis, town cars, trains, shuttles, etc.), or other travel items from a variety of airlines, accommodation providers, rental companies, etc. Further, inventory of each item may be highly volatile, such that the availability of any given travel item (e.g., a specific flight or hotel room) may be altered within a very short time period. In addition, multiple items may be available that meet a user's criteria (e.g., multiple flights or flight combinations to a given destination, multiple hotel rooms within a given city, etc.). However, the search capabilities of a network-based service may not be able to encapsulate all possible combinations of criteria, and therefore may be unable to provide all relevant results to a user based on a given query. Moreover, in some instances, users may be unaware of additional or alternative criteria for locating items on the network-based service.

### BRIEF DESCRIPTION OF THE DRAWINGS

The foregoing aspects and many of the attendant advantages will become more readily appreciated as the same become better understood by reference to the following detailed description, when taken in conjunction with the accompanying drawings, wherein:

FIG. 1 is a schematic block diagram of an illustrative network environment in which a travel service may operate to deliver recommendations for travel packages based on an inference of a traveler's desired travel plan;

FIG. 2 is an illustrative block diagram depicting the generation of usage information associated with the travel service of FIG. 1, which may be used in the generation of travel package recommendations;

FIG. 3 is an illustrative block diagram depicting submission of a travel item query to the travel service of FIG. 1, inference of a traveler's desired travel plan based on the travel item query, and return of travel package recommendations generated based on the desired travel plan;

FIGS. 4A and 4B depict illustrative user interfaces that may be used to facilitate submission of a travel item query to, and delivery of recommendations from, the travel service of FIG. 1; and

FIG. 5 is a flow diagram depicting an illustrative routine for inferring a desired travel plan of a traveler and generating travel package recommendations based on the desired travel plan.

### DETAILED DESCRIPTION

Generally described, aspects of the present disclosure are directed to managing queries for travel items offered or provided via network-based travel services. More specifically, aspects of the present disclosure relate to facilitating the generation of recommended travel queries based on a current query, as well as recommendation of items corresponding to recommended travel queries. Illustratively, a network-based travel service may offer one or more travel items for acquisition, purchase, or booking. Travel item may include items such as flights, hotels or other accommodations, ground transport, activities, etc. A user of the network-based travel service may submit one or more queries including criteria for selecting one or more relevant travel items (e.g., a relevant flight, hotel, rental car, etc.). Thereafter, the service may return any available and relevant travel items. In addition, the service may return recommendations for additional travel queries of interest to the user, or may return items resulting from execution of the additional travel queries. In accordance with embodiments of the present disclosure, additional travel queries may be generated based at least in part on an inference of a desired travel plan of the user. For example, a travel service may infer, based on a user's queries, that the user is interested in vacationing in a particular location. The travel service may generate suggested queries for the user that correspond to the inferred travel plan. For example, the travel service may generate a suggested query for a combination of a flight, accommodation, and transportation. By executing the suggested query, the user may avoid searching for each travel item individually. Further, the suggested query may be generated to ensure that all returned items are compatible with one another (e.g., that times and dates of each item correspond). Accordingly, the user may more easily discover combinations of travel items (e.g., travel packages) that fulfill their desired travel plan.

In a traditional interaction, a user of a network-based travel service (e.g., a service that provides information regarding available travel items from one or more travel item providers) may desire to vacation in a specific region within a range of dates. Accordingly, the user may submit queries for flights to various airports within the region across a range of dates (e.g., in order to find a lowest cost fare). The user may locate a desired flight, and then proceed to submit queries for accommodation compatible with the flight (e.g., near the destination of the flight, beginning on the flight's date of arrival and ending on the flight's date of departure). However, the user may find that accommodation on dates corresponding to the flight is prohibitively expensive. In order to locate a lower total cost, the user may therefore search for accommodation on alternate dates or in alternate locations. However, because such accommodation may be incompatible with the previously selected flight, the user would be required to repeat the previous flight query, until a combination of flights and accommodation is selected which fulfills the desired travel plan of the user (e.g., a vacation in the specific region, within the range of dates, and at a low cost). Because a user conducts queries for each individual travel item in isolation and without regard for compatible travel items, it is unlikely that the user will locate a collection of travel items that provides an optimal solution to their desired travel plan.

In order to facilitate more effective location of combinations of travel items, a user may be presented with generated or predefined travel item combinations. For example, a user searching for flights to a specific region within a range of dates may be presented with flight options, as well as compatible accommodation. However, because such travel item combinations are generally predefined or generated based on the submit query (e.g., for specific flights), the combinations may not be optimal solution to their desired travel plan. For example, the user may be willing to travel to alternative locations or on alternative dates not represented in travel item combinations generated based on the submitted query. Further, a user that submits a query for a flight to a specific location may not actually desire accommodation in that location, but may rather desire to travel outside of the location (e.g., via alternative modes of travel). Due to such a desire, offers for travel item combinations corresponding to the location may not be useful to the user. Further, the number of possible travel item combinations may be very large, and may alter frequently. Due to such volatility, a user is unlikely to be presented with a travel item combination that meets their desired travel plan.

Accordingly, aspects of the present disclosure relate to generating recommendations for travel items or travel item queries based on an inferred travel plan of a user. Illustratively, an inferred travel plan may be a desire to travel to a specific location, a desire to travel within a set of dates or for a set amount of time, a desired travel purpose (e.g., business, leisure), a desire to minimize travel time associated with a travel plan, a desire to minimize cost of a travel plan, a desire for a specific class of service within a travel plan, etc. Specifically, a network-based travel service may monitor queries of a user, and based on such queries, generate an inferred travel plan for the user. For example, a user conducting searches for flights to a specific city as well as hotels within the city may be inferred to desire to travel to the city. As a further example, a user conducting searches for flights to a specific city and for hotels within an outlying region of the city may be inferred to desire to travel to the outlying region, rather than the city itself. Similarly, a user conducting searches for a broad range of dates may be inferred to desire to travel at any time within the given dates, while a user conducting multiple searches for very specific dates may be inferred to desire to travel only on those specific dates.

An inferred travel plan may further be based on additional information regarding the user, such as profile data. For example, a user that frequently purchases first class flights may be inferred to also desire to purchase luxury accommodations or ground transportation. As a further example, a user that frequently flies for business purposes may be inferred to be traveling for business purposes on subsequent searches. In some embodiments, profile data of a user may therefore be utilized to further refine an inferred travel plan.

Subsequent to inference of a user desired travel plan, a number of searches may be generated that are intended to satisfy the desired travel plan. For example, if a user's desired travel plan is to vacation to a region outlying a specific city, searches may be generated for a combination of a flight to the city, accommodations within the outlying region, and ground transportation between the city and the outlying region. Because such a search is generated based on the user's inferred travel plan rather than directly based on their previously conducted searches, the generated search may include travel items never directly indicated by the user. For example, a user may have previously searched for flights to the specific city and accommodations within the outlying region, but not have previously searched for ground transportation. Nevertheless, a recommended search may include a query for ground transportation, is such transportation furthers the desired travel plan (e.g., by reducing travel times). Further, because a search may be generated for a combination of items that satisfy an inferred travel plan, a user is not forced to locate items individually. In some instances, searches may be formulated to locate an optimal combination of travel items, regardless of whether individual travel items within the combination are themselves individually optimal.

In some embodiments, a large number of potential searches may be generated, each directed to locating a combination of travel items that potentially fulfills the desired travel plan. For example, potential searches may be generated for a variety of alternate date sets corresponding to the desired travel plan. As a further example, potential searches may be generated for alternative locations corresponding to the desired travel plan (alternative destination airports, alternate accommodation locations, etc.). Thereafter, each potential search may be ranked or otherwise ordered in order to determine a likelihood that the potential search will return combinations of travel items satisfying the desired travel plan. For example, searches may be ranked based on a total expected travel time associated with combinations returned by the search. Illustratively, searches for flights to a specific airport and accommodations nearby the airport may be ranked more highly than flights to the airport and accommodation very distant to the airport. As a further example, ranking may include an expected price for travel item combinations associated with the search. Illustratively, an expected price may be determined based on similar past searches conducted on the travel service, or by execution of the search to determine a lowest priced travel item combination returned by the search. Ranking of searches may further be based on specific aspects of the inferred travel plan. For example, ranking of an inferred business travel plan may be less dependent on price than ranking of a leisure travel plan. Similarly, ranking of an inferred leisure travel plan may be less dependent on total travel time than ranking of a business travel plan. Further specific examples of ranking will be described in more detail below.

In one embodiment, subsequent to ranking generated searches, such searches may be returned to a user as search recommendations. For example, where a user searches for flights to a specific city, and is inferred to wish to vacation in the city, a number of searches for vacation packages to the city may be provided to the user. Each search may vary in specific aspects of the vacation package, such as specific dates or locations. The user may therefore select a search in order to view travel item combinations corresponding to the search. In this manner, the user is enabled to discover potential travel solutions to their travel plan without searching for individual travel items. In some embodiments, additional information may be provided to a user regarding each recommended search. For example, a user may be notified of a reason for recommending the search. Such a reason may correspond, for example, to one or more ranking metrics described above. For example, a user may be notified that a specific search is recommended because other users conducting similar searches have secured low priced travel item combinations. As a further example, a user may be notified that a specific search is recommended because an average travel associated with combinations corresponding to the search is generally low.

In other embodiments, subsequent to ranking generated searches, one or more of such searches may be executed and used to locate recommended travel item combinations. In this manner, users may be presented with actual travel item combinations, rather than searches for such combinations. For example, the travel service may determine that a search for flights to a specific airport and hotels with a specific region is likely to satisfy a user's travel plan. Accordingly, the travel service may execute the search, and present the user with one or more combinations of flights to the specific airport and hotels within the region. The user may therefore be enabled to view additional information regarding the combination, and to book or otherwise acquire the combination. In this manner, a user conducting searches for one or more individual travel items may be enabled to purchase a combination of travel items that satisfies their desired travel plan.

Though described herein with respect to specific types of travel services, embodiments of the present disclosure may be applied to any travel item, including but not limited to flights, accommodations, other transportation, activities, tours, travel insurance, day trips, destination services, or combinations thereof.

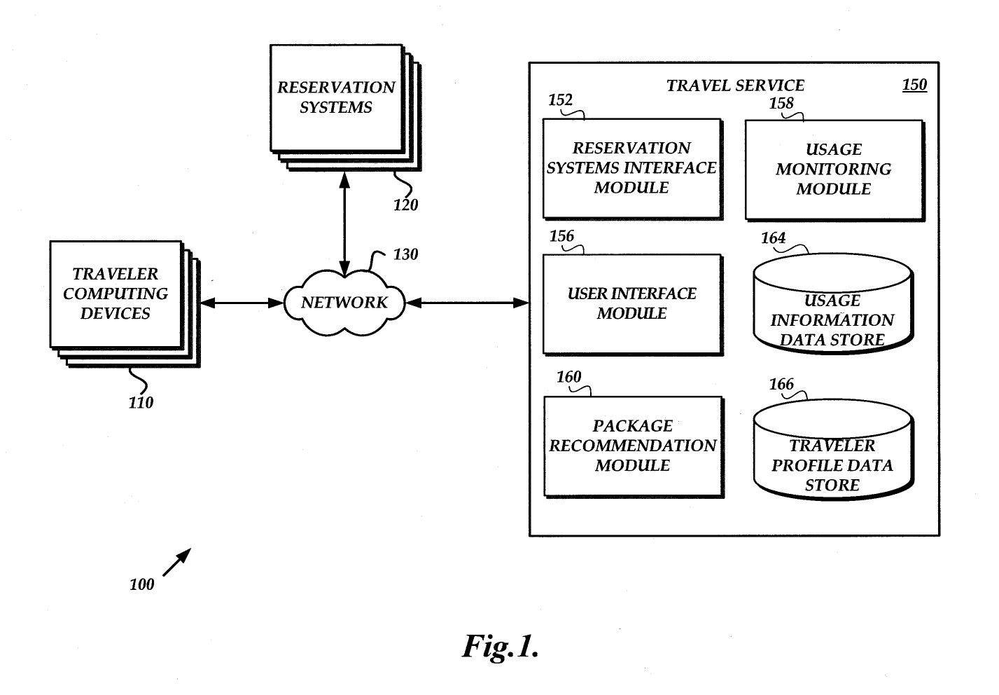

FIG. 1 is a block diagram depicting an illustrative operating environment in which a network-based travel service 150 enables customers to browse, search for, and acquire travel items made available by third party providers or the operator of the travel service 150. As illustrated in FIG. 1, the operating environment includes one or more reservation systems 120 and one or more traveler computing devices 110 in communication with a network-based travel service 150 via a network 130. A third party provider, using a reservation system 120, may make travel items, or information regarding travel items, available to the travel service 150 via the network 130. The travel service 150 may then make the travel items, as well as other travel items, available to traveler computer devices 110. Accordingly, a prospective traveler, using a traveler computing device 110, may browse the travel items available from the travel service 150, search travel items, and acquire, reserve, or book one or more desired travel items.

A traveler computing device 110 may be any computing device, such as a laptop or tablet computer, personal computer, server, personal digital assistant (PDA), hybrid PDA/mobile phone, mobile phone, electronic book reader, set-top box, camera, digital media player, and the like. The reservation systems 120 and the traveler computing devices 120 may communicate with the travel service 150 via a network 130. Those skilled in the art will appreciate that the network 130 may be any wired network, wireless network or combination thereof. In addition, the network 130 may be a personal area network, local area network, wide area network, cable network, satellite network, cellular telephone network, or combination thereof. In the illustrated embodiment, the network 130 is the Internet. Protocols and components for communicating via the Internet or any of the other aforementioned types of communication networks are well known to those skilled in the art of computer communications and thus, need not be described in more detail herein.

The reservation systems 120 may correspond to any systems or devices configured or enabled to allow booking, reservation, or acquisition of travel items. For example, a reservations system 120 may correspond to a centralized reservation system (CRS), a global distribution system (GDS), or any other system where multiple travel item providers, such as airlines, hotels, car rental agencies, cruise lines, bus services, etc., make travel items available for booking, reservation, and/or purchase. In other embodiments, a reservation system 120 may correspond to a system provided by an individual travel item provider (e.g., a specific airline, hotel or hotel chain, car rental agency, cruise line, bus service, etc.). In general, each reservation system may enable other network-based devices, such as devices of the travel service 150 to request information regarding travel items (e.g., availability, price, travel plan, etc.), to search travel items, and to book, acquire, or reserve travel items. Operation of reservation systems is well known within the art, and therefore will not be described in more detail herein.

In the illustrated embodiment, the travel service 150 is illustrated as a computer environment including several computer systems that are interconnected using one or more networks. More specifically, the travel service 150 may include a user interface module 156, a reservation systems interface module 152, a usage monitoring module 158, a usage information data store 164, a package recommendation module 160, and a traveler profile data store 166. However, it will be appreciated by those skilled in the art that the travel service 150 could have fewer or greater components than are illustrated in FIG. 1. In addition, the travel service 150 could include various Web services and/or peer-to-peer network configurations. Additionally, in some embodiments, the travel service may be implemented by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. Thus, the depiction of the travel service 150 in FIG. 1 should be taken as illustrative and not limiting to the present disclosure.

The reservation systems interface module 152 may facilitate interaction with the reservation systems 120, including searching for relevant travel items, retrieving information regarding travel items, and acquiring travel items. In some embodiments, multiple reservation systems interface modules 152 may be provided, each configured to interact with one or more specific reservation systems 120. For example, a first reservation systems interface module 152 may interact with an airline-based reservation system 120, while second reservation systems interface module may interact with a hotel based reservation system 120. Embodiments of systems and methods for interaction with reservation systems 120 are described within U.S. patent application Ser. No. 12/470,442, filed on May 21, 2009, and entitled “OPTIMIZED SYSTEM AND METHOD FOR FINDING BEST FARE,” which is hereby incorporated by reference in its entirety.

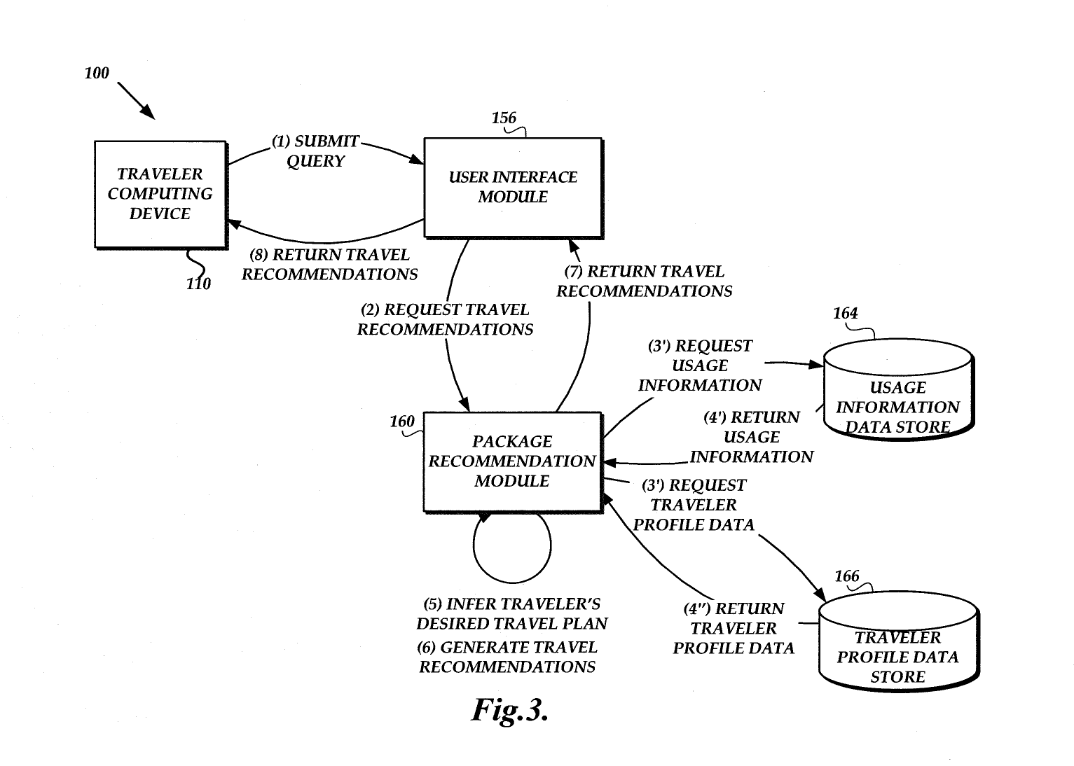

The user interface module 156 may facilitate searching, browsing, and acquisition (e.g., by reservation, booking, etc.) of travel items by travelers via traveler computing devices. In some embodiments, the user interface module 156 may include a web server for generation of webpages facilitating such searching, browsing, and acquisition. Examples of a user interfaces that may be generated by a user interface module 156 will be described in more detail in FIGS. 3A and 3B, below.

The user interface module 156 may further be configured to store, maintain, and acquire information from a traveler profile data store 166. The user information data store 166 may correspond to any persistent or substantially persistent data store, such as one or more hard disk drives (HDDs), solid state drives (SSDs), or network attached storage devices (NASs). The traveler profile data store 166 may store information regarding users, such as a user's name, age, address, date of birth, credit card information, purchase history, and travel reservations, frequent flyer or rewards program information, etc.

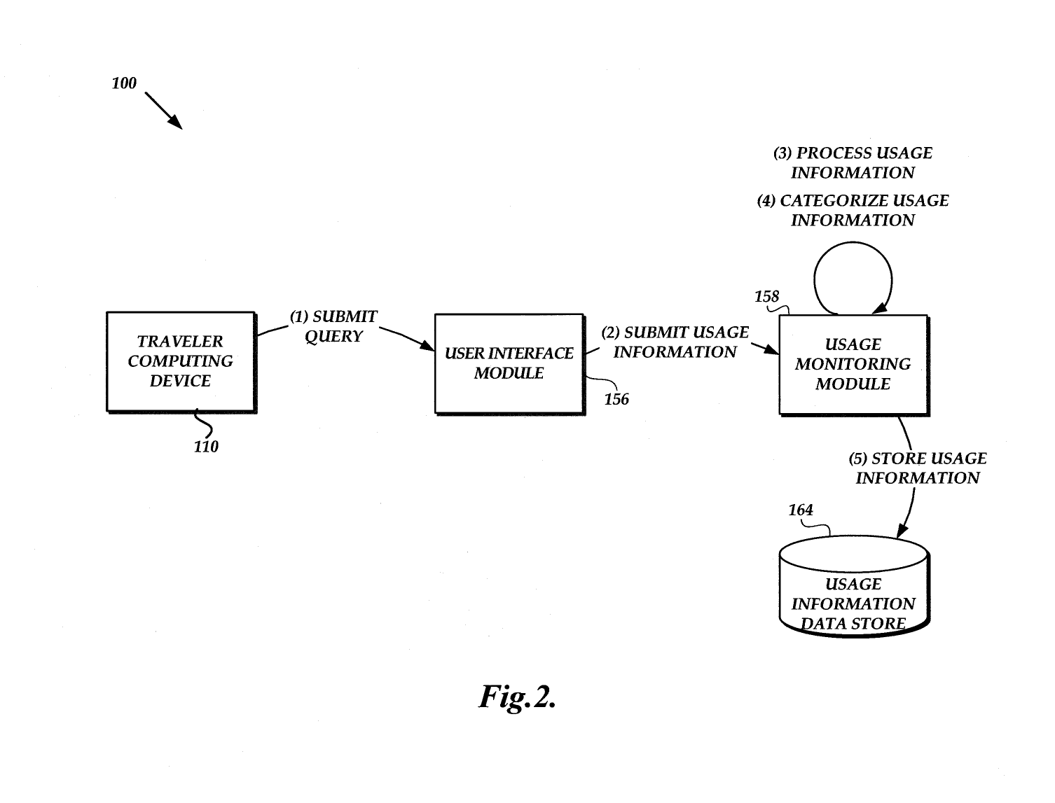

Still further, the user interface module 156 may interact with the usage monitoring module 158 to store usage information of traveler computing devices 110 regarding the travel service 150. For example, the user interface module 156 may transmit information regarding searching, viewing, and acquisition of travel items by travelers to the usage monitoring module 158. The usage monitoring module 158 may transform or otherwise process the information for storage in a data store, such as the usage information data store 162. Illustratively, transformation of the usage information may include anonymization of usage information (e.g., by removal of sensitive or personal information, such as name, address, etc.) or compression of usage information. As will be described in more detail below with respect to FIG. 2A, in some embodiments, the usage monitoring module 158 may further be configured to categorize usage information into a number of relevant categories. For example, a first subset of usage information may be categorized as “business” activities, while a second subset of usage information may be categorized as “leisure” activities. After processing of usage information, the usage information (along with any corresponding categorization information) may be stored within the usage information data store 162. Similarly to the traveler profile data store 166 described above, the usage information data store 162 may correspond to any persistent or substantially persistent data store, such as one or more hard disk drives (HDDs), solid state drives (SSDs), or network attached storage devices (NASs).

The travel service 150 may further include a package recommendation module 160 configured to determine a desired travel plan of a traveler, and generate a number of recommended queries for locating travel item combinations to satisfy such a travel plan. As will be described below, a desired travel plan of a traveler may be inferred based on one or more searches conducted by the traveler on the travel service 150. A desired travel plan may further be inferred based on other information corresponding to the traveler, such as a history of searches conducted by the traveler on the travel service 150 or other services, an acquisition history of the traveler, an inferred location of the traveler, or profile data of the traveler. A desired travel plan may generally correspond to a set of criteria for selection of a combination of travel items. For example, a desired travel plan may specify a type of travel (e.g., business, leisure, family, etc.), a location of travel, a date of travel, or a class or travel (e.g., luxury, economy, etc.). A desired travel plan may further specify constraints for selection of travel items, such as a desire to minimize cost or travel time. Based on the inferred desired travel plan, the travel service 150 may generate a number of searches likely to locate travel item combinations that satisfy the travel plan. For example, where a desired travel plan is to vacation in a given city at a low cost, the travel service 150 may generate a search for flights to the city, as well as accommodation within the city, on a number of dates. The travel service 150 may further rank generated searches, such as by their likelihood to result in a low cost combination of travel items. Thereafter, the searches may be returned to the user as search recommendations, such that the user may select the recommendation to execute the recommended search. Alternatively, the searches may be executed by the travel service 150 to locate recommended travel packages (e.g., combinations of travel items). These travel package recommendations may then be returned to the traveler computing device 110.

With reference to FIG. 2, an illustrative interaction for generating usage information corresponding to the travel service 150 of FIG. 1 will be described. As will be described in more detail below, such usage information may be utilized, for example, in generating travel package recommendations for a traveler computing device 110. In FIG. 2, at (1), one or more traveler computing devices 110 may submit travel queries to the user interface module 156. A travel query may include search criteria for location of one or more travel items desired by a traveler computing device 110. For example, a travel query may correspond to a query for flights, hotels, cars, cruises, travel packages, activities etc. Illustratively, the user interface module 156 may be configured to locate one or more travel items (e.g., by interaction with the reservation systems interface module 152 and one or more reservation systems 120), and to return relevant travel items to the traveler computing devices 110. Because querying for travel items is generally known within the art, the specific interaction for returning relevant travel items will not be discussed in more detail herein.

Usage information generated by or in response to traveler computing devices 110 may, at (2), may be submitted to the usage monitoring module 158. Illustratively, usage information may correspond to the specific search criteria submitted within a traveler query. Still further, usage information may correspond to other activities of the traveler computing devices 110, such as acquisition of travel items (e.g., booking or reservation) on the travel service 150. In some embodiments, usage information may be generated by the user interface module 156 based on information received from the traveler computing devices 110, such as search criteria and requests for acquisition. In other embodiments, usage information may be based at least in part on information received from the traveler computing devices 110. For example, traveler computing devices 110 may be configured to transmit usage information, such as conducted searches, acquisitions, etc., to the user interface module 156 for further transmission to the usage monitoring module 158.

After reception of the usage information by the usage monitoring module 158, the usage monitoring module 158 may, at (3), process the usage information for storage in the usage information data store 162. In some embodiments, processing may include anonymization of the usage information by removing any personal or sensitive data, such as names, specific addresses, payment information, etc. In other embodiments, anonymization may include generalization of data. For example, a specific address of a traveler may be generalized to a corresponding city, region, zip code, area, etc., while removing reference to the traveler's own address. In still more embodiments, usage information may be compressed or otherwise transformed for future storage in the usage information data store 162.

In some embodiments, the usage monitoring module may be further configured to categorize the usage information prior to storage. Categories may be based, for example, on the specific travel item query, on the traveler making the request, or on other actions taken by the traveler. For example, a query for a flight departing early on a Monday morning, and returning on a Wednesday after five o'clock may be categorized as a query by a “business” traveler. In the instance where the specific traveler frequently acquires travel items through the travel service 150, the query may be categorized as conducted by an “elite business” traveler. Conversely, a query for a flight departing on a Friday and returning on a Sunday evening may be categorized as a “leisure” travel. Any number of categories may be utilized, including, but not limited to, business travelers, leisure travelers, vacation travelers, frequent travelers, travelers of a given distance (e.g., short or long distance, distance based on miles, etc.), international or domestic travelers, or travelers from a given location (e.g., traveling from or residing in a certain city, state, region, country, etc.). In addition, categories may be combined. For example, a category may include “elite international leisure travelers from the east coast of the United States.” Generally speaking, the more specific a category, the less usage (e.g., searches and bookings) is likely to be included in the category.

Categorization of usage information, such as conducted searches and acquisition of travel items, may be based on the specific query that resulted in the usage (e.g., the query that facilitated the search, or the query that ultimately lead to acquisition of a travel item). Aspects of a query that may be utilized in order to categorize a given usage include, but are not limited to, the number of travelers searched for, the number of adults or children traveling, the time and date of travel, the length of travel, the provider or brand requested (e.g., airline, hotel chain, etc.), the location of departure or arrival, and the type of travel (e.g., one way, multi-city, round trip, non-stop, one stop, multiple stop). For example, a single traveler may be more likely to be classified as a business traveler than multiple persons traveling together. As a further example, travel including a weekend may be more likely to be classified as leisure or vacation travel than as business travel. Similarly, non-stop flights may be more likely to correspond to business travel than one stop or multiple stop flights. As yet another example, queries for specific destinations, such as tropical areas, may be more likely to be classified as vacation travels.

Categorization of usage information may further be based on activity of the user or profile data of the user. For example, a user that has recently conducted a large number of searches over a span of many days may be more likely to be classified as a leisure or vacation traveler (e.g., if the recent activity indicates a desire to save money and a flexibility of travel dates). Conversely, a traveler who searches on a single date and acquires a travel item relatively quickly may be more likely to be classified as a business traveler (e.g., if the traveler's business is covering costs of the travel item). Similarly, a traveler that has recently visited a number of different travel services may be more likely to be a leisure or vacation traveler than a business traveler. In some embodiments, profile data of a traveler may further be used to classify activity by the traveler. For example, where acquisition history indicates repeated flights to and from the same location, the user's activity may be more likely to be classified as business activity. Similarly, where acquisition history indicates frequent travel to a number of diverse tropical locations, activity of the traveler may be more likely to be categorized as vacation or leisure travel.

Accordingly, the usage monitoring module 158 may be configured to, at (4) categorize each item of usage information (e.g., each submitted search query or travel item acquisition) into one or more categories based on the activity itself, such as the submitted query that resulted in a given search or travel item acquisition. By collection of usage information into one or more categories, the travel service 150 may be enabled to provide future travelers with information specifically targeted to their needs. For example, a traveler submitting a “business” category query may be presented with travel package recommendations intended to satisfy a desired “business” travel plan. Still further, collection of usage information into one or more categories may facilitate rapid selection of relevant usage information (e.g., for the creation of travel package recommendations) by reducing the amount of usage data returned.

After processing and categorization of the usage information, such usage information may be transmitted at (5) to the usage information data store 164 for storage. As will be described in more detail below, such usage information may be utilized by other aspects of the travel server 150, such as the package recommendation module 160, in order to generate travel package recommendations for presentation to traveler computing devices 110.

With reference now to FIG. 3, an illustrative interaction for inferring a desired travel plan for a user of a traveler computing device 110, and for generation of package recommendations based on the inferred travel plan will be described. Specifically, at (1), a traveler computing devices 110 may submit a query for a travel item to the user interface module 156. In some instances, a submitted query may be explicit. For example, the traveler computing device 110 may specifically request information regarding items matching a given criteria. In other instances, a submitted query may be implicit or otherwise inferred (e.g., based at least in part on user activity within the travel service 150). For example, a user may view information regarding flights to Seattle, Wash. for a number of days. In such an instance, it may be that the user is also interested in hotels in Seattle, Wash. during those days. Accordingly, a query for hotels in Seattle, Wash. may be inferred, and package recommendations generated based on an inferred travel plan corresponding to that query may be presented to the user. Accordingly, though embodiments may be described herein with reference to explicit queries, recommendations may be presented based on explicit, implicit, or inferred queries. Moreover, though the interactions of FIG. 3 will be described with respect to a single query, the interactions of FIG. 3 may take place with respect to multiple queries of the traveler computing device 110. For example, the interactions of FIG. 3 may include analysis of multiple queries from a traveler computing device 110 submitted within a short time period or concurrently. As a further example, the interactions of FIG. 3 may include analysis of multiple queries from a traveler computing device 110 submitted over a long period of time, such as over multiple interactive sessions with the travel service 150. Analysis of multiple queries may be beneficial, for example, in order to further refine a desired travel plan inferred from such queries.

As noted above with respect to FIG. 1, the user interface module 156 may be configured to parse the received or otherwise determined query, to determine a number of travel items based on the query, and to return information regarding the travel items to the traveler computing device 110. Because retrieval of travel items based on a query is generally known within the art, such retrieval will not be described with respect to FIG. 3. Further, though not shown in FIG. 3, the user interface module 156 may be configured to generate usage information regarding the submitted query as described above with respect to FIG. 2. Because interactions regarding the generation of usage information are described in detail above, description of such interactions will be not repeated with respect to FIG. 3.

In accordance with aspects of the present disclosure, the user interface module 156 may, at (2), further request a number of package recommendations from the package recommendation module 160. In some embodiments, the user interface module 156 may be configured to pass additional information to the package recommendation module 160 regarding the traveler computing device 110, such as an identified of the traveler computing device 110 or the specifics of the submitted query. In other embodiments, the package recommendation module 160 may be configured to retrieve information regarding the traveler computing device 110 or the submitted query from alternative sources, such as the usage information data store 164, as will be described below.

After receiving a request for package recommendations, the package recommendation module 160 may retrieve information utilized to generate package recommendations. Specifically, at (3′), the package recommendation module 160 may request usage information from the usage information data store 164. The usage information data store 164, in turn, may return the requested usage information at (4′). In one embodiment, the usage information may include data regarding interaction of the traveler computing device 110, such as data regarding the submitted query and/or data regarding previously submitted queries. As will be described below, these queries may be utilized to infer a desired travel plan of the traveler computing device 100. Further, the usage information may include additional information used to generate package recommendations based on an inferred travel plan. For example, the usage information may include data regarding searches conducted by other users, cost or timing information associated with those searches, records of acquisition of travel items by the traveler computing device 110 or other users, etc.

In addition, at (3″), the package recommendation module 160 may request traveler profile data corresponding to the traveler computing device 110 from the traveler profile data store 166. The traveler profile data store 166, in turn, may transmit the requested traveler profiled data to the package recommendation module 160. As will be described below, traveler profile data may be used in part to infer a desired travel plan of a user, or aspects of such a desired travel plan. For example, traveler profile data may be used to determine that the traveler computing device 110 is likely to be traveling for a specific purpose (e.g., business, leisure, family, etc.) or is likely to desire a specific class of service (e.g., luxury, economy, etc.).

After receiving the requested usage information and traveler profile data, the package recommendation module 160 may utilize the usage information and traveler profile data to infer a desired travel plan of the traveler computing device 160. As noted above, a desired travel plan may correspond to any set of criteria used to determine a combination of travel items desired by a traveler computing device 110. Illustratively, a desired travel plan may correspond to a set of dates on which travel is desired, a duration of travel, a location of travel, or specific desired activities (e.g., specific ground services). Further, a desired travel plan may include additional criteria for selection of one or more travel items, such as a desire to minimize cost or travel time or to acquire travel items within a specific category (e.g., luxury, economy, family friendly, etc.).

In one embodiment, a desired travel plan may be determined by determining the most lenient constraints on all travel queries submitted by a traveler computing device 110 within a given period of time. For example, assume a traveler computing device 110 submits a first query for flights to “Miami, Fla.” departing on Jan. 1, 2014 and returning Jan. 7, 2014, and also submits a query for hotels in Miami, Fla. from Jan. 8, 2014 to Jan. 15, 2014. Based on the submitted queries, the package recommendation module 160 may determine that the traveler utilizing the traveler computing device 110 desires to travel to Miami, Fla. at some point between Jan. 1, 2014 and Jan. 15, 2014. Further, the package recommendation module 160 may determine that the traveler wishes to spend a week in Miami, Fla. As a further example, assume a traveler computing device 110 submits queries for flights to multiple airports within a given distance of Miami, Fla. The package recommendation module 160 may therefore infer that the traveler would be willing to travel to a number of airports in order to satisfy their desired travel plan. Conversely, where a traveler computing device 110 makes multiple queries directed to a specific airport, despite the existence of alternative airports within a short distance, the package recommendation module 160 may be likely to infer the traveler wishes to travel to the specific airport.

In other embodiments, aspects of a desired travel plan may be determined based on a subset of queries. For example, assume a traveler computing device 110 submits queries for flights to a first city, and submits queries for accommodations in a second city nearby to the first. In this instance, the package recommendation module 160 may be likely to infer that the traveler desires to travel to the second city, despite submitting queries for flights to the first city. Specifically, the package recommendation module 160 may determine that searches for accommodation are more indicative of a desired location of travel than searches for flights. In some embodiments, the package recommendation module 160 may weigh characteristics of each search to determine a specific aspect of a desired travel plan. For example, a probability of a desired location of travel may be based on a weighted average of the location within each submitted query. Weighting may be based, for example, on the likelihood that the submitted query represents an accurate desired location of travel.

In still more embodiments, aspects of a desired travel plan may be determined based on additional information regarding the traveler computing device 110, such as past acquisitions of the traveler computing device 110 (e.g., as reflected within the received usage information and/or the received traveler profile data). For example, assume that a traveler computing device 110 submits a query for flights to Miami, Fla. Further, assume that the traveler associated with the traveler computing device 110 has previously purchased multiple flights to Miami, Fla. as well as corresponding accommodations in North Miami Beach, Fla. Due to such an association, the package recommendation module 160 may be likely to assume the traveler desires to reach North Miami Beach, Fla. As will be described below, such a desired destination may be used, for example, to suggest alterative airports by which to reach North Miami Beach, Fla., such as Ft. Lauderdale Int'l Airport. As a further example, aspects of a desired travel plan may be determined based on other information regarding the traveler, such as a location of the traveler. For example, a traveler conducting searches for accommodation in the same city in which they're currently located may be unlikely to desire a flight or ground transportation in conjunction with the accommodation. Location of a traveler may be based, for example, based on an address of the traveler computing device 110 (e.g., an interne protocol (IP) address).

Further, information regarding the traveler computing device 110 may reflect additional aspects of a desired travel plan, such as a tendency of a traveler to travel for business purposes or for leisure purposes, or a tendency to travel alone or with family. In general, the package recommendation module 160 may be more likely to assume a traveler is traveling for business purposes when that traveler has a history of such business travel. Moreover, information regarding the traveler computing device 110 may reflect a class of service purchased (e.g., luxury travel items versus economy travel items). Based on a history of purchasing travel items of a specific class, the package recommendation module 160 may infer that the traveler desires to purchase items within that class of service.

In still more embodiments, aspects of a desired travel plan may be determined based on a categorization of one or more queries submitted by a traveler computing device 110. For example, where a traveler has submitted a query categorized as leisure travel (e.g., based on a weekend stay, a tropical destination, etc.), the package recommendation module 160 may be likely to infer that the traveler desires a leisure travel plan. Similarly, where a traveler has submitted a query categorized as business travel, the package recommendation module 160 may be likely to infer that the traveler desires a business travel plan. Categorization of queries is discussed in more detail with respect to FIG. 2, and therefore will not be repeated with respect to FIG. 3.

One skilled in the art will appreciate that a desired travel plan may combine any of the above aspects. For example, dates of a desired travel plan may be determined based on one or more traveler-submitted queries, while a categorization of a desired travel plan may be based on profile data of the traveler. Where a given aspect of a desired travel plan is influenced by more than one factor (e.g., categorization of a search query as well as history of purchases), each factor may be weighted to determine an aspect of the desired travel plan. Accordingly, a desired travel plan may be inferred based on any individual aspect described above or any combination of such aspects. A desired travel plan may further be inferred based on additional or alternative criteria.

After determining a desired itineration, the package recommendation module 160 may, at (6), generate package recommendation corresponding to the desired travel plan. In one embodiment, the package recommendation module 160 may generate package recommendations in the form of queries for combinations of travel items. For example, a package recommendation may correspond to a recommendation to search for flights and accommodations within specific period of time. In other embodiments, the package recommendation module 160 may utilize recommended queries to select travel items combinations for presentation to a traveler computing device 110. For example, the package recommendation module 160 may generate a query intended to return travel packages satisfying a desired travel plan, and may execute the query to return one or more travel packages. These travel packages may then be returned to the traveler computing device 110.

In one embodiment, generation of recommended queries for travel packages may include generation of a number of search permutations corresponding to a desired travel plan. For example, where a traveler desires to travel for three to four days between Jan. 1, 2014 and Jan. 7, 2014, a potential search may be generated for each combination of travel dates between Jan. 1, 2014 and Jan. 7, 2014. Similarly, where a traveler desires to travel to a location served by multiple airports, the package recommendation module 160 may generate searches for flights to and/or from each potential airport. Moreover, where a desired travel plan includes both a range of potential dates and of potential locations, searches for a number of possible combinations satisfying the potential dates and locations may be generated.

Further, in some embodiments, generation of recommended queries may include a determination of additional travel items that may satisfy a desired travel plan. For example, where a traveler has submitted searches for a flight to a specific airport, and a hotel a long distance from the airport, the package recommendation module 160 may determine that ground transportation would be necessary to satisfy the desired travel plan. Accordingly, the package recommendation module may generate queries including available ground transportation options.

In still more embodiments, one or more constraints associated with the desired travel plan may be relaxed in order to generate additional recommended searches. For example, where a desired travel plan includes a small range of dates, recommended searches may be generated for dates just outside the given range. In some embodiments, such relaxation of criteria may occur even when a fairly large range of dates is specified by a user. Further, relaxation of criteria is not limited to dates, but may include any criteria, such as location, class of service, ratings of travel items, desired cost, etc. In some instances, geographical location may be relaxed by selecting alternative locations physically near a desired location. In other instances, geographical location may be relaxed by selective alternative locations similar to a desired location, regardless of distance. For example, if a traveler desires to travel to specific tropical vacation destination, additional searches may be generated for alternative tropical vacation destinations, regardless of proximity to the originally specified destination.

By relaxing of one or more criteria corresponding to a desired travel plan, additional searches may be generated, thereby increasing the potential of locating travel packages that satisfy other criteria of the desired travel plan (e.g., low price).

Moreover, as will be described in more detail below, the package recommendation module 160 may be configured to rank one or more generated searches. Ranking of generated searches may include, for example, a ranking of how closely the search corresponds to a desired travel plan, a cost of travel packages associated with the search (e.g., based on execution of the search or historical data related to the search), a total travel time of travel packages associated with the search, a class of travel items associated with the search, or ratings or reviews of travel items associated with the search (e.g., based on other users of the travel service 150), or a popularity or frequency of execution of the search or similar searches among other users of the travel service 150. Ranking may be beneficial, for example, where a large number of searches potentially satisfy a desired travel plan. Illustratively, a traveler computing device 150 may be presented with only a threshold number of highly ranked search recommendations, rather than all potential search recommendations.

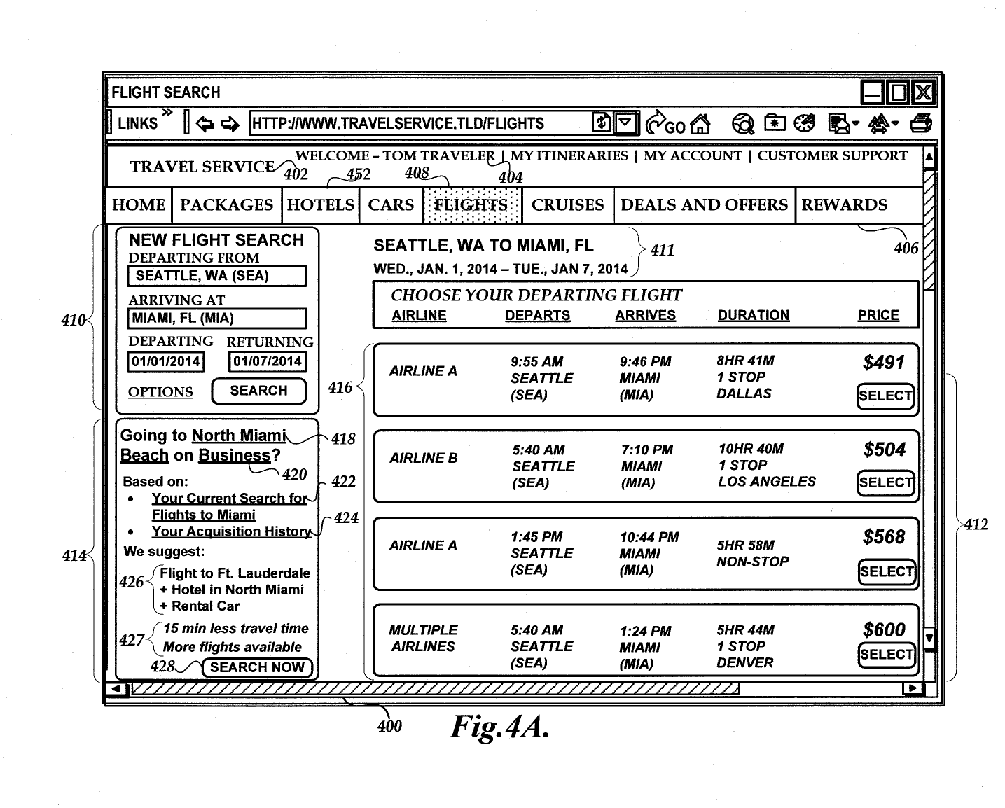

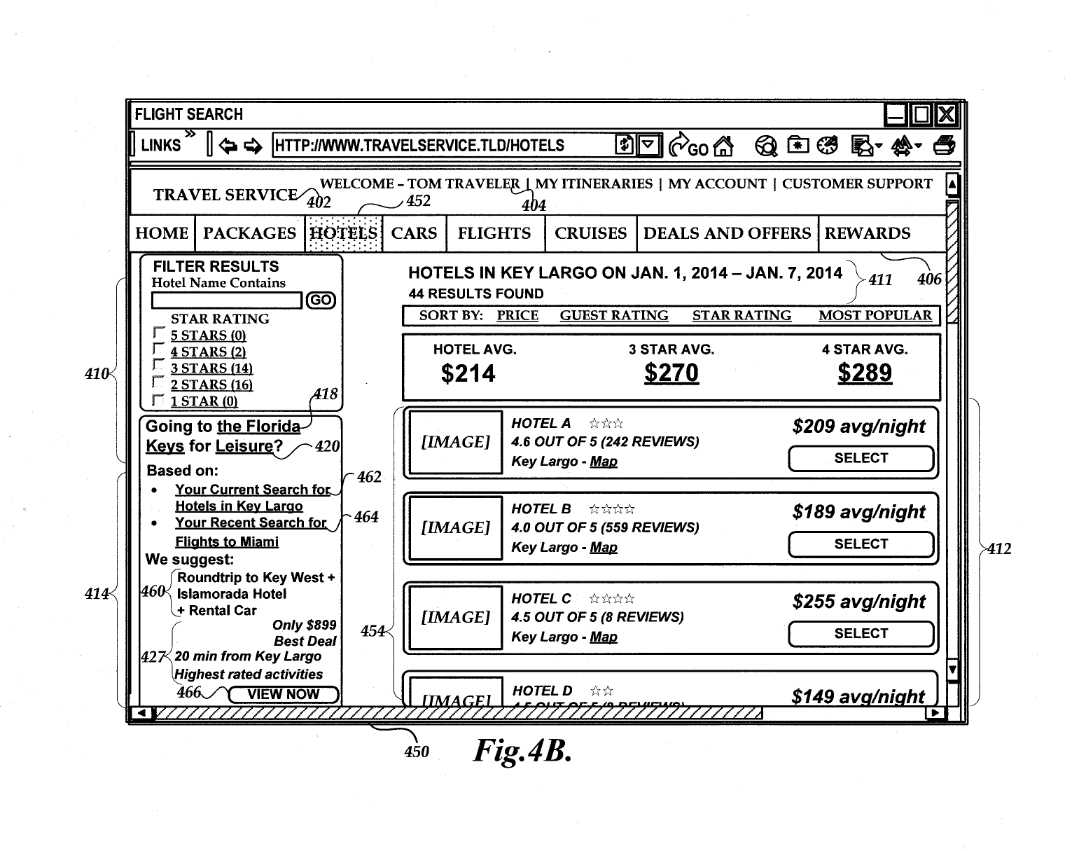

In one embodiment, search recommendations generated by the package recommendation module 160 may, at (7), be returned to the user interface module 156 as package recommendations. The user interface module 156 may, in turn, transmit the package recommendations to the traveler computing device 110. Accordingly, the traveler computing device 110 may be informed of searches likely to return travel packages that satisfy the traveler's desired travel plan. One illustrative interface for display of recommended searches will be described with respect to FIG. 4A, below.

In another embodiment, the package recommendation module 160 (or other components of the travel service 150) may, instead of or in addition to providing search recommendations to the traveler computing device 110, utilize the search recommendations to determine one or more travel packages corresponding to a recommended search. These travel packages may then be returned to the traveler computing device 110. In this manner, the traveler computing device 110 may be presented with one or more travel packages likely to satisfy their desired travel plan. One illustrative interface for display of recommended travel items will be described with respect to FIG. 4B, below.

With reference to FIGS. 4A and 4B, illustrative examples of a user interfaces for delivery of recommendations to a traveler computing device 110 (e.g., in response to a query for travel items) is displayed. As shown in FIGS. 4A and 4B, the user interfaces 400 and 450 enable a traveler computing device 110 to submit travel queries, to view available travel items in response to a submitted travel query, and to view travel package recommendations generated based at least in part on the submitted travel query. Illustratively, the user interfaces 400 and 450 may be generated by the user interface module 156 and presented on the traveler computing device 110 by an application, such as a browser application, on the provider computing device 110. Though shown in two figures, one skilled in the art will appreciate that the user interfaces 400 and 450 may represent two potential embodiments of a single interface. One skilled in the art will further appreciate that travel computing device 110 may be enabled to view each embodiment by interaction with the respective interface (e.g., selection of various inputs within the interface). For example, the user interface 400 as shown in FIG. 4A may represent a potential user interface presented to a traveler computing device 110 at a first point in time, such as after submission of a first travel query. Similarly, the user interface 450 may represent a potential user interface presented to a traveler computing device 110 at a second point in time, such as after submission of a second travel query.

With reference to FIG. 4A, the depicted a user interface 400 may enable a traveler, via a traveler computing device 100, to submit queries for a travel item of a first type, such as flights. The depicted user interface 400 contains a title reference 402 to the travel service 150, i.e., the “Travel Service,” as well as a salutation 404 to the traveler currently visiting the travel service 150. In the illustrated example, the traveler is identified as “Tom Traveler.” The user interface 400 further contains a navigation panel 406, which directs the traveler to various other features offered by the travel service 150. Illustratively, units of text within the navigation panel 406 may correspond to interactive links, which modify or change the user interface when selected. In the current example, Tom Traveler has selected link 408, “Flights.” Based on this selection, the user interface module 156 has returned the content for user interface 400. Tom Traveler may be enabled to view alternative user interfaces by selection of alternative links within the navigation panel 406. For example, Tom Traveler may view the user interface 450 of FIG. 4B by selection of the “Hotels” link 452, as will be described below.

By use of the user interface 400, the traveler computing device 110 may submit a travel query to the travel service 150, including criteria for determining relevant travel items. Illustratively, such a query may be submitted by use of the search portion 410 of the user interface 400. As shown in FIG. 3, the search portion 410 enables a traveler to specify criteria for relevant flight travel items, such as departure location and date, and arrival location and date. Though a limited set of search criteria is provided in FIG. 3, one skilled in the art will appreciate that additional or alternative criteria may be specified by the traveler computing device 110, including but not limited to, time of departure or arrival, flight provider, type of travel (e.g., non-stop, one-stop, non-stop), and price. Accordingly, the criteria described with respect to FIG. 4A is intended to be illustrative, and not limiting.

In the illustrative user interface 400, the criteria displayed in the search portion 410 may be reflective of a previous search submitted by the traveler computing device 110. Accordingly, a number of relevant travel items are shown within the results portion 412, including a listing of travel items 416. Each individual travel item within the listing of travel items 416 corresponds to a travel item available for acquisition by the traveler. Further, each individual travel item may have been selected based on the submitted search criteria, as reflected by the search criteria potion 411. In the current example, each individual travel item corresponds to a round-trip flight from Seattle, Wash. to Miami, Fla. on Wednesday, Jan. 1, 2014 and returning Tuesday, Jan. 7, 2014.

In addition, the user interface 400 includes a recommendation display portion 414 that includes a recommended query 426. The recommended query 426 may represent a recommendation generated by the travel service 150 based on an inference of Tom Traveler's desired travel plan. For example, the travel service 150 may utilize the submitted query (e.g., as reflected in the search criteria portion 411) in addition to other information, such as purchasing history or profile information of Tom Traveler, to infer a desired travel plan of Tom Traveler. In some embodiments, the travel service 150 may provide an indication of one or more rationales 422 and 424 for inferring the travel plan. For example, rationale 422 indicates the desired travel plan was determined based in part on the currently executed search, while rationale 424 indicates the desired travel plan was determined based at least in part on an acquisition history of the current user. Though an illustrative interface for providing rationales is discussed herein, any combination of rationales may be provided to a traveler computing device 150. For example, the user interface 400 (or an alternate user interface) may display a complete history of recent searches conducted on the travel service 150 (e.g., in a timeline). Each of the rationales 422 and 424 may be selectable by a user to modify inference of a desired travel plan based on the respective rationale, such as to remove the rationale as a basis from which to infer a travel plan.

Further, the travel service 150 may generate a number of recommended searches likely to return travel packages satisfying the desired travel plan. One or more of these searches may then be presented to Tom Traveler via the recommendation display portion 414. Further, the recommendation display portion 414 may also provide information regarding the inferred travel plan. For example, the recommendation display portion 414 may reflect that presented recommendations are based on an inferred destination 418 of “North Miami Beach.” Such an inferred destination may be based, for example, on previously submitted searches by Tom Traveler, or based on an acquisition history of Tom Traveler. The recommendation display portion 414 may further reflect that presented recommendations are based on an inferred purpose 420 of “Business” travel. Each of the inferred destination 418 and inferred purpose 420 may be selectable by the user to alter the recommendations. For example, if Tom Traveler is not planning on traveling for business, he may be enabled to alter the inferred purpose 420 by selection of a link corresponding to the inferred purpose.

The recommendation display portion 414 further includes search information 426 corresponding to the recommended search. Specifically, the search information 426 reflects that the travel service 150 recommends searching for flights to Ft. Lauderdale, Fla. (e.g., rather than Miami, Fla.), a hotel in North Miami Beach, and a rental car. Such a recommended search may be generated by the travel service 150 based on an inferred travel plan. For example, because the travel service 150 has inferred that Tom is traveling to North Miami Beach, Fla. for business purposes, the recommend search may have been selected to minimize travel time between an airport and North Miami Beach. Further, the travel service 150 may assume that business travelers desire flight availability more strongly than flight cost, and therefore may have selected the recommended search in order to maximize flight availability. In order to better inform travelers of potential benefits of the modified search, one or more rationales 427 for presentation of the recommended search may be presented within the user interface 400 alongside the recommended search information 426. In some embodiments, such rationales 427 may correspond to metrics used to generate or rank the recommended search.

Further, the user interface 400 may include a recommendation selection input 428 that enables Tom Traveler to execute the recommended search. For example, selection of input 428 may cause the traveler computing device 110 to submit a query for a travel package including flights to Ft. Lauderdale, a hotel in North Miami, and a rental car. By executing such a search, Tom Traveler may be enabled to locate a combination of travel items that satisfies his desired travel plan.

With reference now to FIG. 4B, a second user interface 450 for submitting queries for a travel item of a second type, such as hotels or lodging, will be described. As noted above, the user interface 450 may represent a modified version of the user interface 400 of FIG. 4A. For example, the user interface 450 may be presented to a traveler computing device 110 in response to selection of the “Hotels” link 452 within FIG. 4A. Because many display elements of FIG. 4B are similar to those of FIG. 4A, and because numbering of such elements is maintained between FIGS. 4A and 4B, these elements will not be described in detail with respect to FIG. 4B.

In one embodiment, the user interface 400 of FIG. 4B may be displayed in response to submission of a second query by Tom Traveler, such as a query for a hotel or other accommodation. Illustratively, Tom Traveler may not have located a travel package that satisfies his desired travel plan within the user interface 400 of FIG. 4A, and may therefore have submitted a second query for hotels or accommodations. Accordingly, the user interface 450 may reflect search criteria 411, indicating that Tom Traveler has searched for accommodation in Key Largo, Fla. from Jan. 1, 2014 to Jan. 7, 2014. The user interface 450 may further include a number of travel items 454-458 meeting the search criteria 411. For example, travel item 454 may reflect an offering for “Hotel A” at a rate of $209 per night. Similarly, travel items 456 and 458 may reflect an offering for “Hotel B” at a rate of $189 per night and an offering of “Hotel C” at a rate of $255 per night, respectively. The user interface 450 may further include one or more controls for interacting with the information regarding travel items, such as search refinement controls 410. For example, portions of the search refinement controls 410 may enable a user to refine offered hotels by hotel name or by star rating. One skilled in the art will appreciate that multiple additional controls may be made available to users.

In addition, the user interface 450 includes a recommendation display portion 414 that includes a recommended travel package 460. The travel package 460 may represent a recommendation generated by the travel service 150 based on an inference of Tom Traveler's desired travel plan. Illustratively, the travel service 150 may utilize the immediately submitted query for accommodation in Key Largo, Fla. (e.g., as reflect in the search criteria portion 411) in conjunction with the previously submitted query for flights to Miami, Fla., to infer that Tom Traveler desires to vacation within the Florida Keys. Information regarding the inferred travel plan may be displayed, for example, within the inferred destination 418 and the inferred purpose 420. In addition, as described above with respect to FIG. 4B, the interface 400 may provide one or more rationales for the inferred travel plan. For example, the current user interface 400 depicts rationales 462 and 464, indicating that the current travel plan was based at least in part on the current search for hotels to Key Largo, Fla. as well as a previous search for flights to Miami, Fla. (e.g., as described above with respect to FIG. 4B).

Based on the inference described above, the travel service 150 may generate a number of recommended travel packages likely satisfy the desired travel plan. For example, the travel service 150 may determine that a vacation to the Florida Keys may be satisfied by a flight to Key West, rental of a car, and accommodation at Islamorada, as reflected within the recommendation information 460. The displayed recommendation may be generated based on criteria corresponding to the inferred travel plan. For example, because the travel service 150 has inferred that Tom is traveling to the Florida Keys for leisure purposes, the recommend search may have been selected to minimize a total cost of all travel items. Further, the travel service 150 may assume that leisure travelers desire access to activities, such as those rated highly by other users of the travel service 150. Accordingly, the specific travel item combination recommended by the travel service 150 may attempt to minimize cost while allowing access to those activities. In order to better inform travelers of potential benefits of the recommended travel package, one or more rationales 427 may be presented within the user interface 400 alongside the recommended search information 426. In some embodiments, such rationales 427 may correspond to metrics used to generate or rank the recommended travel package among a plurality of possible travel packages.

Further, the user interface 450 may include a recommendation selection input 466 that enables Tom Traveler to view further details regarding the recommended travel package. By selecting input 466, Tom Traveler may be enabled to view specific information regarding the recommended travel package, and to potentially acquire the recommended travel package, thereby satisfying criteria of his desired travel plan.

Though illustrative user interfaces 400 and 450 are described above with respect to FIGS. 4A and 4B, recommendations may be provided to a user via any number of or type of interfaces. For example, as described above, queries may be implicit within or otherwise inferred based on user activity (e.g., on prior services, on the travel service 150, etc.). Accordingly, recommendations may be included within any user interface from which a query can be determined. For example, a traveler viewing information on hotels in a given city may be inferred to be interested a travel plan including a stay within or near the city. Accordingly, recommendations may be generated based at least in part on such an inferred travel plan and provided within a user interface containing information regarding the hotel. Still further, in some embodiments, travel package recommendations may be provided via other interfaces, such as application programming interfaces (APIs). Accordingly, the user interfaces 400 and 451 of FIGS. 4A and 4B should be viewed as illustrative, and not limiting.

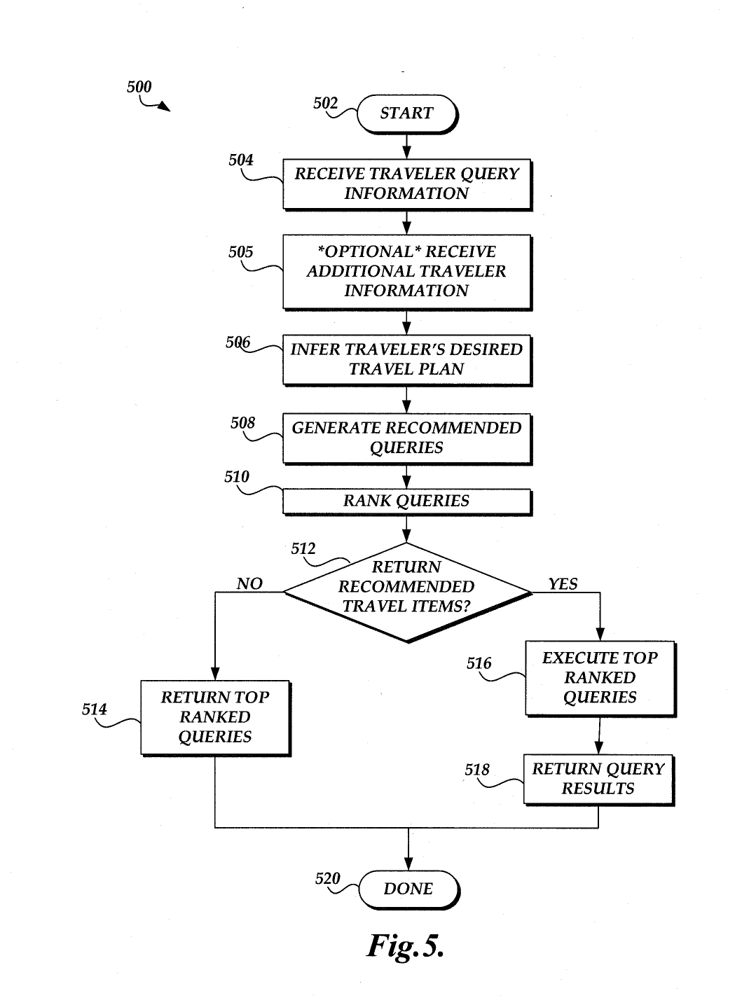

With reference now to FIG. 5, one illustrative routine 500 for generation of travel package recommendations and delivery of such recommendations to a traveler computing device 110 will be described. The illustrative routine 500 may be carried out, for example, by the package recommendation module 160 of FIG. 1. The routine 500 may begin at block 504, where the package recommendation module 160 may receive information corresponding to one or more queries made by a traveler computing device (e.g., a traveler computing device 100 of FIG. 1). Optionally, at block 505, the package recommendation module 160 may further receive additional traveler information, such as traveler profile information or acquisition histories, that may be used to infer a desired travel plan of the traveler.

Subsequent to receiving traveler query information, the package recommendation module 160 can infer a traveler's desired travel plan based on the traveler query information and any available additional information. As described above with respect to FIG. 2, a traveler's desired travel plan may correspond to a set of criteria used to determine a combination of travel items that the traveler desires, as opposed to a single set of criteria for determining a single travel item. For example, a traveler's desired travel plan may correspond to a leisure trip to a tropical location in June of 2014 at a low cost. As a further example, a traveler's desired travel plan may correspond to a two-week luxury cruise in the Mediterranean on one of three specific dates. Because each traveler submitted query may correspond only to a subset of criteria for a desired travel plan (e.g., only one of multiple possible dates, only one of multiple desired travel items, etc.), inference of a traveler's desired travel plan may therefore enable the package recommendation module 160 to generate additional recommended queries to satisfy the traveler's desired travel plan.

As noted above with respect to FIG. 2, in some embodiments, all or a portion of a set of criteria corresponding to a traveler's desired travel plan may be determined based at least in part on a set of queries submitted by the traveler. For example, where a traveler has submitted queries for travel items on multiple dates, each date may be inferred to be acceptable within a traveler's desired travel plan, or a range of dates may be generated based on the multiple dates. As a further example, where a traveler has searched for flights to multiple locations, each location may be inferred to be acceptable to the traveler. A traveler's desired travel plan may further be determined based on additional information regarding the traveler, such as profile information, travel item viewing history, travel item acquisition history, or traveler location information. For example, traveler profile information may indicate a preference for one or more brands of travel item (e.g., via indication of membership in a frequent traveler program or rewards program). As a further example, traveler acquisition history may indicate previously purchased travel item combinations or packages which include at least one travel item similar to those a traveler has recently searched for. Due to such similarities, it may be inferred that the traveler would be interested in travel item combinations similar to those previously purchased. Still further, traveler acquisition history or profile data may indicate a preference for specific types or classes of travel items.

After determining a traveler's desired travel plan, the package recommendation module 160 may generate one or more queries based on the desired travel plan. Specifically, the package recommendation module 160 may generate all or a subset of all possible queries that match the set of criteria corresponding to the desired travel plan, but that have not yet been executed by the traveler computing device 110. For example, an inferred travel plan may correspond to a vacation in the Florida Keys in early January of 2014. A traveler computing device 110 may have previously searched for flights to Miami, Fla. departing Jan. 1, 2014 and returning Jan. 8, 2014, as well as accommodations in Key Largo, Fla. However, the package recommendation module 160 may determine that flights to and from any combination of Ft. Lauderdale, Fla., Key West, Fla., or Miami, Fla. may also satisfy the desired travel plan. Further, the package recommendation module 160 may determine that accommodations in any of the islands of the Florida Keys would satisfy the desired travel plan. Such determinations may be based, for example, on geographical information of each potential travel item (e.g., airport or hotel location) as well as geographical information of the desired travel plan (e.g., a vacation within the Florida Keys).

In some embodiments, the package recommendation module 160 may further be configured to determine searches including additional travel items necessary or helpful to fulfilling a desired travel plan, regardless of whether such travel items have been searched for by the traveler. For example, where a generated query includes a search for flights to a given airport and accommodation more than a threshold distance away from the airport, the package recommendation module 160 may modify the query to include a search for ground transportation. In this manner, the travel items located by each generated query may be insured to be compatible with one another.

Further, in some embodiments, the package recommendation module 160 may be configured to generate queries for travel items not directly matching the criteria of a desired travel plan, but nearly matching such criteria. For example, the package recommendation module 160 may be configured to generate queries for dates near, but not within, the set of criteria corresponding to a desired travel plan. As a further example, the package recommendation module 160 may be configured to generate queries for alternative locations, classes of service, trip durations, etc. In this manner, the traveler's potential options for travel item combinations may be increased. Further, though such generate queries may not exactly satisfy a desired travel plan in one respect (e.g., date desired), they may represent a more optimal solution to the desired travel plan in another aspect (e.g., price).

Because the number of generated queries may be large, in some embodiments, it may be beneficial to rank generated queries according to an estimated likelihood that the query will be of interest to a traveler. For example, where hundreds of queries are generated based on the traveler's desired travel plan, but only a threshold number of queries may be included within a display page transmitted to the user, the package recommendation module 160 may select only the highest ranked threshold number of queries to display. In one embodiment, ranking of queries may be determined based on how closely the queries correspond to the set of criteria associated with the desired travel plan. For example, a query that directly corresponds to desired dates of the travel plan may be more highly ranked than a query which does not directly correspond to desired dates. In other embodiments, queries may be ranked based at least in part on travel item combinations associated with the query. For example, if a travel plan is associated with a desire for low cost, a query that returns travel item combinations of an average low cost may be ranked higher than queries that return travel items of average higher costs. Costs associated with queries may be determined, for example, by utilizing historical cost information associated with the query or similar queries (e.g., a lowest cost travel package booked within the last day). As a further example, costs associated with queries may be determined based at least in part by executing the query on the travel service 150. Illustratively, execution of queries may provide a more accurate indication of real time costs associated with travel items. In some embodiments, the travel service 150 may modify cost information associated with queries to provide a more accurate view of potential costs of the traveler. For example, the travel service 150 may modify potential costs to reflect any discounts or promotions available to the traveler (e.g., based on affiliation, location, profile data, etc.).

In some embodiments, ranking of queries may further be based on information generated based on activities of other users of the travel service 150. For example, a high number of executions of a given query (or other queries similar to the given query) by users of the travel service 150 may indicate a high demand for travel items corresponding to the query. In one embodiment, a rank of frequently conducted (e.g., popular) queries may be reduced, since popularity may indicate a rise in prices or a lowering in availability. In other embodiments, a rank of frequently conducted queries may be increased, since popularity may indicate desirability of travel items corresponding to the query.

In still more embodiments, each criteria corresponding to a desired travel plan may be weighted, and each generated query may be assigned a score based on how closely each aspect of the query confirms to the weighted criteria. For example, a desired travel plan may be associated with low cost criteria and a desired date criteria. However, the low cost criteria may be more highly weighted than the desired date criteria. Based on such weighting, a query associated with low cost travel items not within the desired dates may be ranked more highly than a query associated with high cost travel items within the desired dates. By use of such ranking, the package recommendation module 160 may determine those queries most likely to return travel items conforming to the desired travel plan.

After determining a ranking of each generated query, the package recommendation module 160 may determine whether to the generated query recommendations, or to return travel item combinations corresponding to the query recommendations. As noted above with respect to FIGS. 4A and 4B, in one embodiment, recommend queries themselves may be presented to traveler computing devices 110, such that selection of a recommended query causes execution of the query on the travel service 150. Delivery of recommended queries may be beneficial, for example, to allow travelers to determine the specific recommended search criteria. Accordingly, if delivery of query recommendations is desired, the routine 500 may continue at block 514, where at least a threshold number of highly ranked queries may be returned to the traveler computing device 110 (e.g., via the user interface 400 of FIG. 4A). Thereafter, the routine 500 may end at block 520.

In a second embodiment, travel items corresponding to the recommended queries may be returned. For example, the travel service 150 may be configured to execute a threshold number of generated queries, and to determine one or more travel items resulting from the query. Determination of travel items may be beneficial, for example, in order to enable travelers to directly select recommended travel items that satisfy their desired travel plan (e.g., without requiring the traveler to execute an additional query). Accordingly, if delivery of travel items corresponding to query recommendations is desired, the routine 500 may continue at block 516, where a threshold number of highly ranked queries may be executed on the travel service 150 to determine travel item combinations corresponding to the query. Thereafter, one or more of such determined travel item combinations may be returned to the traveler computing device 110 (e.g., via the user interface 450 of FIG. 4B). Thereafter, the routine 500 may end at block 520.

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The steps of a method, process, routine, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An example storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A computer-implemented method for generating travel item recommendations in response to travel item queries, the method comprising:
as implemented by one or more computing devices configured with specific executable instructions,
receiving queries for travel items of at least two different types from a user computing device associated with a user;
determining, based at least in part on the received queries, a desired travel plan of the user, wherein the desired travel plan corresponds to a set of criteria for determining a combination of travel items of the at least two different types desired by the user, and wherein the set of criteria is broader than criteria specified within the received queries
generating a plurality of recommended queries for the desired travel plan based at least in part on the set of criteria corresponding to the desired travel plan, wherein each of the plurality of recommended queries is distinct from the received queries; and
transmitting the plurality of recommended queries to the user computing device.

2. The computer-implemented method of claim 1, wherein a travel item type comprises at least one of a flight, accommodation, ground transportation, activity, tour, travel insurance, day trip, or destination service.

3. The computer-implemented method of claim 1, wherein the set of criteria corresponding to the desired travel plan includes two or more of a desired date of travel, a desired trip duration, a desired destination, a desired destination type, a desired cost, a desired travel time, a purpose of travel, a desired travel item type, a desired rating of travel items, or a desired class of service.

4. The computer-implemented method of claim 1, wherein each criterion within the set of criteria is associated with a weight indicative of the criterion's relative desirability within the desired travel plan.

5. The computer-implemented method of claim 1, wherein the desired travel plan of the user is further determined based at least in part on profile data of the user.

6. A system for generating travel item recommendations in response to a travel item query, the system comprising:
one or more processors configured to at least:
receive a query for an item from a computing device associated with a user;
determine, based at least in part on the received query, a desired travel plan of the user, wherein the desired travel plan corresponds to a set of criteria for determining a combination of items of at least two different types desired by the user;
generate a recommended query for the desired travel plan based at least in part on the set of criteria, wherein each of the plurality of recommended queries is distinct from the received query; and
transmit to the computing device at least one of (1) the recommended query or (2) travel items determined based least in part on the recommended query.

7. The system of claim 6, wherein the one or more processors are further configured to:
determine potential recommended queries based at least in part on the desired travel plan; and
rank the potential recommended queries based at least in part on the set of criteria;
wherein the recommended query is generated based at least in part on the ranking of the potential recommended queries.

8. The computer-implemented method of claim 7, wherein each criterion within the set of criteria is associated with a weight indicative of the criterion's relative desirability within the desired travel plan.

9. The computer-implemented method of claim 8, wherein the rank of a potential recommended query is based at least in part on the weights associated with each criterion within the set of criteria.

10. The computer-implemented method of claim 8, wherein the rank of a potential recommended query is based at least in part on historical data associated with at least one query similar or identical to the potential recommended query.

11. The computer-implemented method of claim 10, wherein the historical data includes a lowest priced travel item combination associated with the at least one query similar or identical to the potential recommended query.

12. A non-transitory computer-readable storage medium having computer-executable instructions that, when executed by one or more processors, cause the processers to at least:
in response to reception of a query for a travel item from a computing device associated with a user, determine a desired travel plan of the user based at least in part on the received query, wherein the desired travel plan corresponds to a set of criteria for determining a combination of items of at least two different types desired by the user;
generate a recommended query for the desired travel plan based at least in part on the set of criteria, wherein the recommended query is distinct from the received query; and
transmit to the computing device at least one of (1) the recommended query or (2) a combination of items determined based at least in part on the recommended query.

13. The non-transitory computer-readable storage medium of claim 12, wherein the desired travel plan of the user is further determined based at least in part on profile data of the user.

14. The non-transitory computer-readable storage medium of claim 12, wherein the desired travel plan of the user is further determined based at least in part on an acquisition history of the user.

15. The non-transitory computer-readable storage medium of claim 12, wherein the desired travel plan of the user includes a preference for a category of desired items.

16. The non-transitory computer-readable storage medium of claim 15, wherein the category corresponds to at least one of business, leisure, family, elite, luxury, or economy.

17. The non-transitory computer-readable storage medium of claim 12, wherein the computer-executable instructions further cause the one or more processors to:
determine potential recommended queries based at least in part on the desired travel plan; and
rank the potential recommended queries based at least in part on the set of criteria;
wherein the recommended query is generated based at least in part on the ranking of the potential recommended queries.

18. A computer-implemented method for generating travel item recommendations in response to a query, the method comprising:
in response to reception of a query for a travel item from a computing device associated with a user, determining a desired travel plan of the user based at least in part on the received query, wherein the desired travel plan corresponds to a set of criteria for determining a combination of items of at least two different types desired by the user;
generating a recommended query for the desired travel plan based at least in part on the set of criteria, wherein the recommended query is distinct from the received query; and
transmitting to the computing device at least one of (1) the recommended query or (2) a combination of items determined based at least in part on the recommended query.

19. The computer-implemented method of claim 18 further comprising transmitting a reason for recommendation of the recommended query or combination of items.

20. The computer-implemented method of claim 19 further comprising:
determining potential recommended queries based at least in part on the desired travel plan; and
ranking the potential recommended queries based at least in part on the set of criteria;
wherein the recommend query is generated based at least in part on the ranking of the potential recommended queries.

21. The computer-implemented method of claim 20, wherein a rank of each potential recommended query is determined based at least in part on a historical execution of the potential recommended query by additional users.

22. The computer-implemented method of claim 19, wherein the desired travel plan of the user is further determined based at least in part on profile data of the user.

23. The computer-implemented method of claim 19, wherein the desired travel plan of the user is further determined based at least in part on an acquisition history of the user.

24. The computer-implemented method of claim 19, wherein the desired travel plan of the user is further determined based at least in part on a location of the user.
